(19) United States
(12) Patent Application Publication
(10) Pub. No.: US 2011/0246793 A1
(43) Pub. Date: Oct. 6, 2011

(54) METHOD OF PROVIDING OUT OF BAND MONITORING AND CONTROL OF A DATA STORAGE SUBSYSTEM

(75) Inventor: David M. Davis, Portsmouth (GB)

(73) Assignee: Xyratex Technology Limited, Havant (GB)

(21) Appl. No.: 12/752,664

(22) Filed: Apr. 1, 2010

(51) Int. Cl. G06F 1/26

(52) U.S. Cl. 713/300

(57) ABSTRACT

The invention provides a method of providing out of band monitoring and/or control of a data storage subsystem, the storage subsystem comprising one or more storage media, a controller for controlling the storage media and a power supply unit, the method comprising: providing out of band control and/or monitoring signals to and/or from the power supply unit.

The present invention relates to a method of providing out of band monitoring and control of a data storage subsystem, a method of providing out of band monitoring and control of a data storage system, a data storage subsystem and a data storage system.

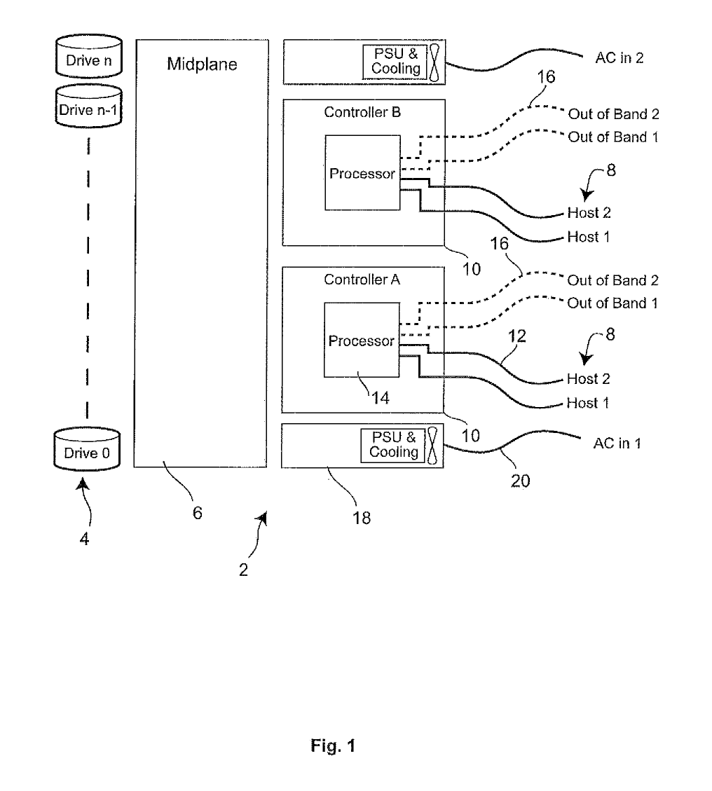

FIG. 1 is a schematic representation of a storage subsystem 2. Within a rack storage system plural subsystems are typically provided.

The subsystem 2 comprises plural storage media 4 such as hard disk drives. The hard disk drives 4 are connected via a midplane 6 to, typically, two or more hosts 8. The connection to the hosts 8 is made via controllers 10 which function as input/output units to control the flow of data to and from the data storage media. In this case two controllers, labelled “Controller A” and “Controller B” are provided. Each controller in a subsystem will have 2 or more host connections 12 as primary data connections, i.e. the primary connections by which data is transferred from the hosts to the plural storage media 4. These primary connections would typically be SAS or Fibre Channel. In addition to the data over these channels 12, they are also used for monitoring and control of the enclosure via ‘in-band’ control. An example of this would be SCSI Enclosure Services (SES), where drive and enclosure status is returned to the host via the main high speed data connection. The controllers 10 each have a processor 14, such as a microprocessor, which operates to control the function of the controller.

In the example shown, and as is typical for such systems, the controllers 10 also have other methods for monitoring and/or control, examples including Serial, I2C, or Ethernet. These other methods are termed “Out of Band” since they are not in the primary data path, and usually connect to a dedicated monitoring and control computer (not shown). Out of Band connections 16 are provided for the transmission and receipt of the Out of Band control signals. The additional communications infrastructure required to monitor a datacentre or rack based system thus normally includes network interface on system components such as the input/output modules, Ethernet hubs/switches within the rack system (including power supplies), and any associated or required cabling.

Power supply and cooling units 18 are provided. Two such independent units 18 are provided so that there is redundancy in the power supply, such that if one fails, the enclosures can continue to operate from the other. Power is received by the power supply and cooling units 18 from a respective power line 20. The power supply and cooling units 18 condition and control the power prior to supplying it to the components of the storage system 2. In a typical subsystem the power is supplied to a power rack from which other components of the storage subsystem 2 are driven.

According to a first aspect of the present invention, there is provided a method of providing out of band monitoring and/or control of a data storage subsystem, the storage subsystem comprising one or more storage media, a controller for controlling the storage media, and a power supply unit, the method comprising: providing out of band control signals to and/or from the power supply unit.

Thus, there is a provided a means by which the same level of out of band control can be provided without requiring the additional cabling and sockets etc that are usually required. Out of band control and/or monitoring signals can be sent via the power supply unit. This means the system provided hereby enables a reduction in the usually required adapters and cabling thus simplifying the system and improving resilience. Furthermore, since in such storage subsystems redundancy is usually provided in the power supply, use of the power supply to provide out of band control necessarily provides redundancy in this too. Previously, if redundancy were to be provided in the out of band control then double the additional hardware would have been required. In other words, although previous systems (such as that described above with reference to FIG. 1) work well, connection in this manner requires additional cabling and connectors which adds to the part count and cost for such a system. This can be avoided by use of the present method.

In an embodiment, the out of band control signals are provided using powerline Ethernet.

In an embodiment, an external AC connection is provided for the power supply unit and the out of band control and/or monitoring signals are provided via the external AC connection of the power supply unit.

According to a second aspect of the present invention, there is provided a method of providing out of band monitoring and control of a data storage system in which the data storage system comprises plural data storage subsystems each comprising one or more storage media, a controller for controlling the storage media and a power supply unit, the method comprising: providing out of band control signals to and/or from the power supply units.

In an embodiment, the out of band control signals are provided using powerline Ethernet.

In an embodiment, the out of band control signals are provided via the external AC connection of the or each of the power supply units.

In an embodiment, the data storage system comprises a power distribution unit to receive AC power from a source and distribute the power to the data storage subsystems, the method comprising receiving via the power distribution unit out of band control signals from the power supplies of the data storage subsystems.

Use of the power distribution units provides redundancy as there is inherent redundancy provided by the PDUs which can be used for the out of band control too.

In an embodiment, the out of band control signals received via the power distribution unit are provided to a workstation for processing.

In an embodiment, data relating to one or more of power usage, thermal environment and control functions of the system and subsystems is provided from the power distribution unit additional.

According to a third aspect of the present invention, there is provided a data storage subsystem, comprising: plural data storage media; one or more control units for controlling the flow of data into and/or out of the plural data storage media; a power supply unit having an external power supply connection, the power supply unit being arranged to supply power to the data storage system, wherein the power supply unit includes a controller coupled to the one or more control units for sending and/or receiving out of band control signals to the data storage system via the external power supply connection.

In an embodiment, the controller is a powerline Ethernet converter.

According to a fourth aspect of the present invention, there is provided a data storage system, comprising: two or more data storage subsystems according to the third aspect of the present invention; and a power distribution unit arranged in use to receive power from an external source and provide the power to each of the power supply units.

In an embodiment, a common output is provided for routing of out of band control signals from plural of the data storage subsystems. A single output from the PDU can be used to route all the out of band control data as required. Typically this might be routed via an RJ45 cable or other such connection means.

In an embodiment there are provided two or more power distribution units thereby providing redundancy in the provision of out of band control signals monitoring.

Embodiments of the present invention will now be described in detail with reference to the accompanying drawings, in which:

FIG. 1 is a schematic representation of a storage subsystem;

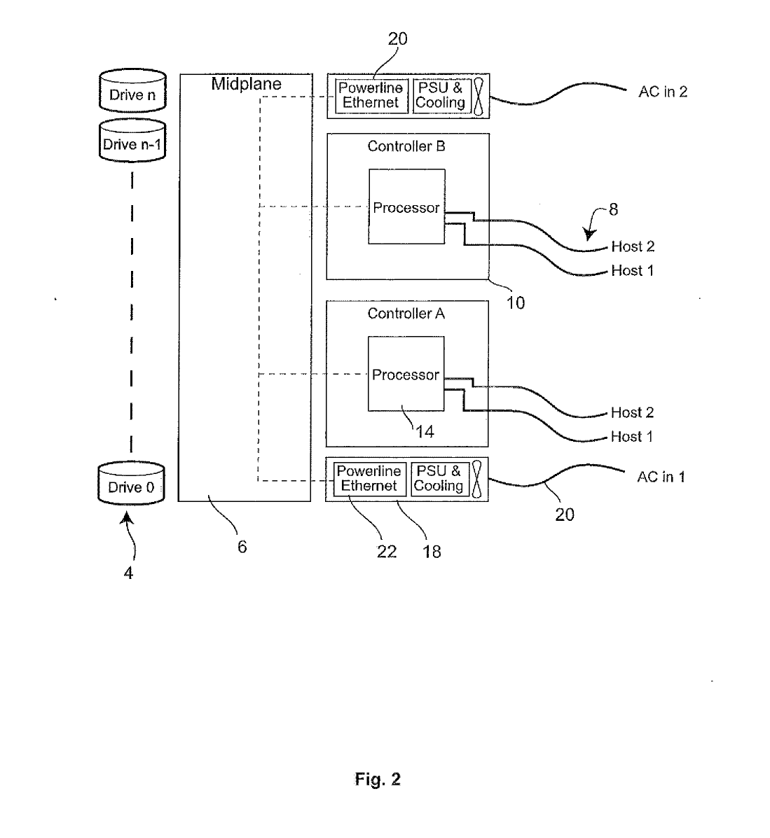

FIG. 2 is a schematic representation of a storage subsystem; and,

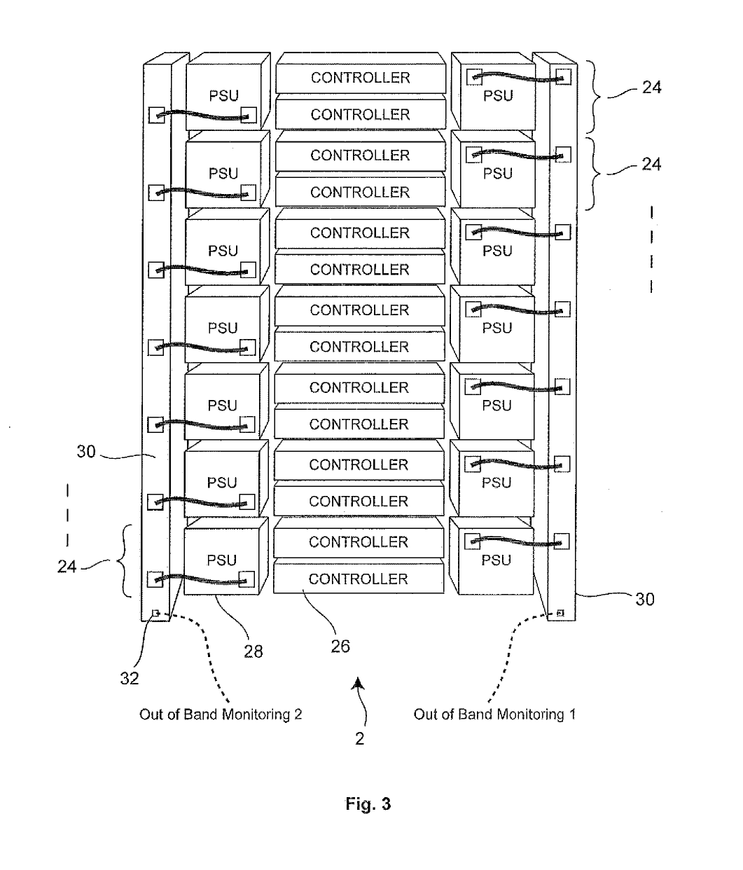

FIG. 3 is a schematic representation of a storage system including a power distribution unit.

FIG. 2 is a schematic representation of a storage subsystem according to one example of an embodiment of the present invention. Like the subsystem of FIG. 1, the storage subsystem includes plural storage media 4 such as hard disk drives. The hard disk drives 4 are connected via a midplane 6 to, typically, two or more hosts 8. The connection to the hosts 8 is made via controllers 10 which function as input/output units to control the flow of data to and from the data storage media. Each controller has 2 or more host connections 12 as primary data connections.

The power supply units 18 each comprise a control unit 22 such as a Powerline Ethernet unit which enables out of band control and data signals to be sent via the power lines 20. The control unit 22, which might be a Powerline Ethernet convertor device is located in the power supply units 18 and is connected to the controller processors 14. The Powerline Ethernet convertor device provides the Out of Band interface via its external AC connection. Connection in this manner reduces the number of cables connected to each enclosure and, when the subsystem is arranged within a data storage system including plural subsystems, this arrangement can simplify the monitoring of racks of equipment by connection through the rack power distribution units.

The power supply units thus provide two functions which include both power supply to the system and also the provision and control of Out of band control and/or monitoring signals. Fewer cables are therefore needed in the system and so the number of sockets required on the controllers is correspondingly reduced.

Conventionally, i.e. in a subsystem such as that shown in FIG. 1, significant additional communications infrastructure is required to monitor a data centre or rack based storage system. This can entail network interface on system components such as the controllers 10 or I/O modules, Ethernet hubs/switches within the rack system (including power supplies) and the requisite additional cabling. In contrast, the present system integrates the network interface into the storage subsystem power supply and utilises the power connection as the transmission media for the out of band network traffic.

The control unit 2 may be provided by an appropriate chipset or other hardware. An example of a chipset suitable for providing this function is the DSS9003 (DS2) from Design of Systems on Silicon S.A. As explained in the accompanying data sheet for the chipset, the entire contents of which is hereby incorporated by reference, the DSS9003 can handle up to 262,144 MAC addresses and features an optimized Spanning Tree Protocol for fast reconfiguration in the event of optical or other network failures. The DSS9003 may be used for connecting a medium voltage grid to a WAN by means of two integrated Gigabit Ethernet ports. It can also be used as part of high-performance Medium Voltage/Low Voltage gateways.

The present system utilizes PowerLine adapters that might be used in home networking and integrates these devices into a power supply of a data storage subsystem to allow monitoring and communication of the subsystem state via its power supply without additional hardware or cabling. Since power supplies are dual redundant and AC is normally sourced from 2 different inputs, each power supply unit could connect to a different monitoring network and thus provide resilience.

In comparison to conventional systems, the present system enables a significant reduction of adaptors and cabling which simplifies the system and improves resilience. Furthermore, there is provided inherent redundant network capability through the normal dual redundant storage subsystem power supply units. In other words, since the provision of power is done on a redundant basis, i.e. there is redundancy built into the power provision by the use of two or more independent AC sources, redundant network capability will also be provided.

There is no need to provide external network interface on the I/O modules. Data could be passed internally to the PSU via another interface (I2C, RS/232, Ethernet etc). Where a PDU is used, a single monitoring point connection for the complete rack system of equipment can be provided.

FIG. 3 is a schematic representation of a storage system including a power distribution unit. The system 2 is a typical rack configuration containing plural enclosures or storage subsystems 24, each containing two controllers 26 and two PSUs 28. Each of the storage subsystems 24 might be of the type shown in and described with reference to FIG. 2.

Within the storage system two Power Distribution Units (PDUs) 30 are provided, one on either side to provide power to the system. The provision of at least two PDUs is required if redundancy is to be provided in the power supply. In this example, an Out of Band monitoring port 32 is provided from which a connection is made to a monitoring workstation such as a PC. It can thus be appreciated that the redundancy built into the AC power supply, it is also provided for the Out of Band monitoring. Although in most situations it is expected that a monitoring or control port be provided on the PDU, this is not required in all embodiments. The out of band monitoring and control does not require a monitoring port on the PDU; it could just plug into the same AC circuit. In other words the monitoring or control port could be inside or outside of the rack. In one embodiment, it could cover a group of racks with one monitoring port at the incoming AC distribution for the datacentre.

It will be appreciated that the PDUs serve to consolidate the out of band network traffic from all units within the rack. In one example, an RJ45 connection is provided out to a monitoring workstation such as a PC. In one embodiment, the PDUs provide additional data into this network monitoring workstation such as power usage, thermal environment etc, providing a single information/monitoring connection for the rack system. Control functions such as enable/disable power to certain outputs etc could also be provided.

Embodiments of the present invention have been described with particular reference to the examples illustrated. However, it will be appreciated that variations and modifications may be made to the examples described within the scope of the present invention.

1. A method of providing out of band monitoring and/or control of a data storage subsystem, the storage subsystem comprising one or more storage media, a controller for controlling the storage media and a power supply unit, the method comprising:
providing out of band control signals to and/or from the power supply unit.

2. A method according to claim 1, in which the out of band control signals are provided using powerline Ethernet.

3. A method according to claim 1, in which the out of band control signals are provided via the external AC connection of the power supply unit.

4. A method of providing out of band monitoring and/or control of a data storage system in which the data storage system comprises plural data storage subsystems each comprising one or more storage media, a controller for controlling the storage media and a power supply unit, the method comprising:
providing out of band control signals to and/or from the power supply units.

5. A method according to claim 4, in which the out of band control signals are provided using powerline Ethernet.

6. A method according to claim 4, in which the out of band control signals are provided via the external AC connection of the or each of the power supply units.

7. A method according to claim 4, in which the data storage system comprises a power distribution unit to receive AC power from a source and distribute the power to the data storage subsystems, the method comprising receiving via the power distribution unit out of band control signals from the power supplies of the data storage subsystems.

8. A method according to claim 7, in which the out of band control signals received via the power distribution unit are provided to a workstation for processing.

9. A method according to claim 7, comprising providing from the power distribution unit additional data relating to one or more of power usage, thermal environment and control functions of the system and subsystems.

10. A data storage subsystem, comprising:
plural data storage media;
one or more control units for controlling the flow of data into and/or out of the plural data storage media;
a power supply unit having a power supply connection, the power supply unit being arranged to supply power to the data storage system via the power supply connection, wherein the power supply unit includes a controller coupled to the one or more control units for sending and/or receiving out of band control and/or monitoring signals to the data storage system via the power supply connection.

11. A data storage subsystem according to claim 10, in which the controller is a powerline Ethernet converter.

12. A data storage subsystem according to claim 10, comprising an external AC line or socket for providing a channel for out of band control signals to a monitor station, such as a PC.

13. A data storage system, comprising:
two or more data storage subsystems according to claim 10; and
a power distribution unit arranged in use to receive power from an external source and provide the power to each of the power supply units

14. A data storage system according to claim 13, in which a common output is provided for routing out of band control signals from plural of the data storage subsystems.

15. A data storage system according to claim 13, comprising two or more power distribution units thereby providing redundancy in the provision of out of band control signals monitoring.

16. A method according to claim 5, in which the data storage system comprises a power distribution unit to receive AC power from a source and distribute the power to the data storage subsystems, the method comprising receiving via the power distribution unit out of band control signals from the power supplies of the data storage subsystems.

17. A method according to claim 8, comprising providing from the power distribution unit additional data relating to one or more of power usage, thermal environment and control functions of the system and subsystems.

18. A data storage subsystem according to claim 11, comprising an external AC line or socket for providing a channel for out of band control signals to a monitor station, such as a PC.

19. A data storage system, comprising:
two or more data storage subsystems according to claim 11; and
a power distribution unit arranged in use to receive power from an external source and provide the power to each of the power supply units.

20. A data storage system according to claim 14, comprising two or more power distribution units thereby providing redundancy in the provision of out of band control signals monitoring.
